(19) United States
(12) Patent Application Publication
(10) Pub. No.: US 2008/0049426 A1
(43) Pub. Date: Feb. 28, 2008

(54) Wearable colored light signaling apparatus

(76) Inventor: Jason Ledderhos, Santa Clara, CA (US)

Correspondence Address: JASON LEDDERHOS, 827 Christopher Ct., Santa Clara, CA, 95051, US

(21) Appl. No.: 11/510,458

(22) Filed: Aug. 28, 2006

(51) Int. Cl. F21S 13/14

(52) U.S. Cl. 362/252

(57) ABSTRACT

This invention is a wearable array of colored lights that can be dynamically controlled from a hand held user friendly interface. This embodiment can be adapted for use with other devices that are also worn. The device of the current invention is operated by pressing the user interface buttons to activate the colored light array. The colored light array is small and versatile. It can be utilized to accommodate the user's needs.

### BACKGROUND

1. Field of Invention

This invention relates to a colored light array, specifically to a colored light array that is wearable and controllable.

2. Background

Colored light arrays have been used for automotive traffic signaling. The traffic signals are big and power intensive. The colored light arrays used in automotive traffic signals are on time controlled preset patterns. If you wanted a way to use a colored light array for your own signaling, it would be awkward to use a traffic signal.

### SUMMARY

My invention relates to a colored light array that is small enough to wear and controlled by a simple user interface that would allow a user to utilize a colored light array for their own personal use.

### OBJECTS AND ADVANTAGES

Accordingly, several objects and advantages of my invention are a small and light weight array of colored lights that can be worn and controlled by the user. This invention provides an easy user interface controller with a way for the user to wear the colored light array and control it at the same time for maximum usefulness.

### DESCRIPTION OF DRAWINGS

FIG. 1 is a general perspective of the apparatus showing a user interface controller, male and female wire jacks, connecting wire, battery terminal, colored light array, and ear hook.

FIG. 2 shows a wiring diagram from a female wire jack to colored lights in a colored light array.

FIG. 3 shows a wiring diagram from a female wire jack to user interface controller buttons in a user interface controller base.

### REFERENCE NUMERALS IN DRAWINGS

| | |
|---|---|
| 1 | ear hook |
| 2 | colored light array base |
| 3 | blue light |
| 4 | orange light |
| 5 | green light |
| 6 | yellow light |
| 7 | red light |
| 8 | female wire jack |
| 9 | male wire jack |
| 10 | connecting wire |
| 11 | male wire jack |
| 12 | female wire jack |
| 13 | controller base |
| 14 | blue light controller button |
| 15 | orange light controller button |
| 16 | green light controller button |
| 17 | yellow light controller button |
| 18 | red light controller button |
| 19 | batter terminal |
| 20 | connecting screws |

### Description

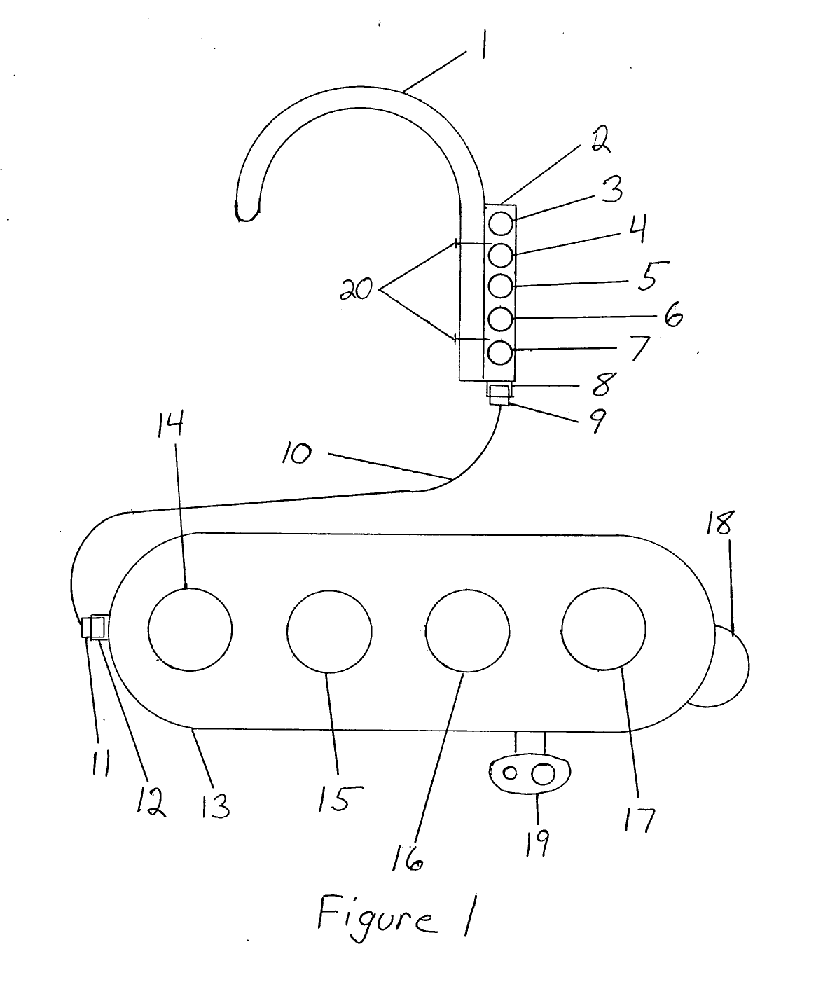

FIG. 1 shows the preferred embodiment of the present invention. A colored light array base 2 is used to hold lights 3,4,5,6 and 7 in an array. An ear hook 1 is mounted onto the colored light array base 2 with connecting screws 20. A female wire jack 8 is secured onto the colored light array base 2. A male wire jack 9 is plugged into the female wire jack 8. The male wire jack 9 is connected to a connecting wire 10. The connecting wire 10 is connected to a male wire connecter 11. The male wire connecter 11 is plugged into a female wire connecter 12. The female wire connecter 12 is secured onto a controller base 13. The controller base 13 is used to hold controller buttons 14,15,16,17 and 18. A Battery terminal 19 is secured to the controller base 13.

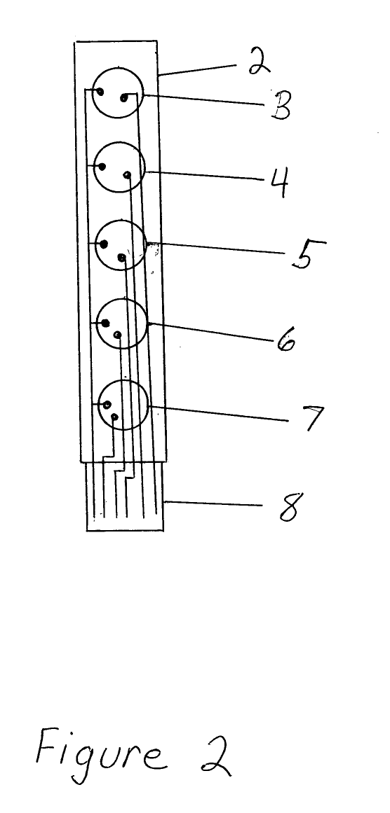

FIG. 2 shows a wiring diagram of lights 3,4,5,6 and 7 in the light array base 2 to the female wire jack 8.

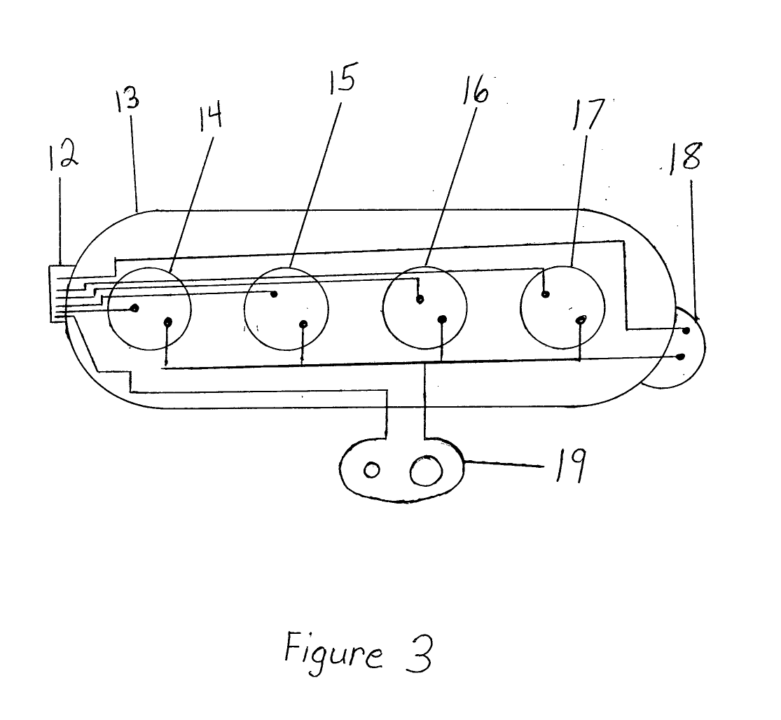

FIG. 3 shows a wiring diagram of the controller buttons 14,15,16,17 and 18 in the controller base to the female wiring jack 12 and the battery terminal 19.

### Operation

The operation of my invention begins with wearing the light array by securing the ear hook 1 around user's ear. Holding the controller in one hand with fingers positioned on controller buttons 14,15,16,17 and 18, the user can control the colored light array by pushing down on controller buttons 14,15,16,17 and 18. This will correspondingly activate lights 3,4,5,6 and 7 respectively in the colored light array. A battery is connected to the battery terminal 19 to provide power to the colored light array.

### CONCLUSION

Thus the reader will see that the current invention will allow a user a way to wear and control an array of colored lights. While my above description contains many specificities, these should not be construed as limitations on the scope of the invention, but rather as an exemplification of one preferred embodiment thereof. Many other variations are possible. For example, there can be any number of colored lights in many other types of structured arrays. The securing means can be incorporated in any wearable device such as eye glasses, audio headset, or phone headset. Accordingly, the scope of the invention should be determined not by the embodiment illustrated, but by the appended claims and their legal equivalents.

I claim:

1. A wearable colored light signaling apparatus comprising of (a) a plurality of colored lights, (b) at least one first means for providing dynamic control of said plurality of colored lights, and (c) a second means for securing said plurality of colored lights to a user wearby allowing the user to wear and dynamically control said plurality of colored lights.

2. The wearable colored light signaling apparatus of claim 1 wherein said plurality of colored lights is an array of blue, orange, green, yellow, and red colored lights.

3. The wearable colored light signaling apparatus of claim 1 wherein said second means for securing said plurality of colored lights is an ear hook that is worn around the ear.
